(19) United States
(12) Patent Application Publication
(10) Pub. No.: US 2002/0141622 A1
(43) Pub. Date: Oct. 3, 2002

(54) Fingerprint impressing position guiding method and fingerprint identification system

(75) Inventor: Seiji Yamaguchi, Yonezawa-shi (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/107,448

(22) Filed: Mar. 28, 2002

(30) Foreign Application Priority Data
Mar. 28, 2001 (JP) 2001-093806

(51) Int. Cl. G06K 9/00

(52) U.S. Cl. 382/126

(57) ABSTRACT

A fingerprint identification system, which can reduce repetitions of erroneous fingerprint input operations, includes a fingerprint input sensor on which an individual to be identified places a finger, which reads a fingerprint from the finger; a processor which determines a center of the fingerprint which is read by the fingerprint input sensor and calculates a gap between a center of the fingerprint input sensor and the center of the fingerprint; and a guiding unit which notifies a move direction to the individual based upon the gap and guides the finger to a proper position.

### BACKGROUND OF THE INVENTION

The present invention relates to a fingerprint identification system, more specifically, to a technique capable of preventing repetitions of erroneous fingerprint input operation in such a fingerprint identification system.

Nowadays, “security” problems are considered in various fields. In initial stages for securing such a “security” aspect, there is a problem as to how to eliminate an individual who has no access right, and how to allow access operation by only an individual who owns access right. To solve this problem, various sorts of individual identifying methods have been proposed. Among these identifying methods, fingerprint identification systems are being considered as the individual identifying method that is most effective and has the highest reliability.

While using such a feature of fingerprints that none of people can have the same fingerprint pattern as another, fingerprint identification systems may electronically read out fingerprints so as to specify previously-registered individuals. In most of the fingerprint identification system, when an individual to be identified puts his/her finger on an input sensor for judging a fingerprint, a fingerprint of this finger is electronically read, and a check is made whether or not this read fingerprint is made coincident with fingerprint data which has been previously registered. As a result, these fingerprint identification systems confirm whether or not the individual to be identified corresponds to the identified individual.

However, although these fingerprint identification systems may have superior characteristics as the individual identifying method, there is such a risk that the fingerprint identification systems may not always surely recognize such identified individuals who have been previously registered in these identification systems. In a certain case, even if a fingerprint of an individual to be identified has been surely previously registered, such a fingerprint identification system may judge that there is no identified individual. This problem is most probably caused by a so-called “erroneous fingerprint input operation,” in which a finger of an individual to be identified is placed on a position of an input sensor, which is shifted from a center portion of the input sensor.

As conventional systems capable of avoiding, or reducing such an “erroneous fingerprint input operation,” Japanese Patent Application Laid-open No. Sho 62-170230 discloses the system (will be referred to as “prior art 1” hereinafter) and Japanese Patent Application Laid-open No. Hei 3-226888 discloses the system (will be referred to as “prior art 2” hereinafter). The prior art 1 opens such a system that while the contour lines corresponding to several sorts of finger sizes are displayed by the input means, since the individual to be identified puts the finger on the input means in such a manner that the finger size of this individual is fitted to the relevant contour line, the positional shift between the finger position during the registration and the finger position during the identification can be reduced.

Meanwhile, the prior art 2 discloses such a system that the finger tip holding unit employed in the finger guide is provided in such a manner that either at least a portion or an entire portion of the fingerprint impressing plane may be surrounded. Also, in accordance with the prior art 2, the positional shift can be prevented by such a manner that while the individual to be identified inserts the finger along the finger guide, the finger tip portion of this individual to be identified is held by the finger tip holding unit so as to restrict the position of this finger tip portion.

However, even when the above-explained systems disclosed in the prior art 1 and the prior art 2 are conducted, these conventional systems cannot avoid occurrences of-such an “erroneous fingerprint input operation,” and thus, may most probably judge that there is no identified individual. This is because there are many numbers of finger sizes different from each other, and also, individual to be identified do not always placed on their fingers on input sensors under such desirable conditions made by system designers.

Moreover, since these systems described in the prior art 1 and the prior art 2 do not consider such cases, the individual to be identified cannot apparently grasp how the finger putting position is shifted, but also cannot know whether or not the finger putting position is positionally shifted in accordance with these conventional systems. As a consequence, there are some possibilities that the erroneous fingerprint input operation is repeatedly carried out.

### SUMMARY OF THE INVENTION

Thus, the present invention has an object to provide a guiding method of a fingerprint impressing position, and a fingerprint identification system using this guiding method of the fingerprint impressing position, which may reduce repetitions of erroneous fingerprint input operations.

The Inventors of the present invention considered that, as described above, the problems contained in the conventional systems may be caused by such a point that after the judgement is made of “no identified individual,” the fingerprint identification system does not notify to the individual to be identified, such a fact whether or not the fingerprint impressing position is incorrect with respect to the fingerprint input sensor. In accordance with the conventional fingerprint identification system, when the judgement is made of “no identified individual,” the individual to be identified cannot recognize whether or not the position of the finger placed on the input sensor is such a proper finger putting position. Also, when the judgement is made of “no identified individual,” the individual to be identified will retry to put his/her finger on the input sensor in order to identify the individual himself/herself. However, due to the same previously-explained reason, there are many possibilities that the individual to be identified repeatedly performs the same erroneous fingerprint input operation.

The present invention has been made to consider this point, and therefore, is featured by that when a judgement is made that no relevant individual is present as a result of fingerprint identification, a calculation is carried out as to how degree a positional coordinate value of a finger placed on a fingerprint input sensor is shifted from a center portion of the sensor, and then, proper guidance information is outputted to an external output apparatus. As a consequence, an individual to be identified can explicitly grasp “erroneous fingerprint input operation,” and can put the finger more properly with respect to the finger input sensor fingerprint impressing position when the individual again puts the finger on the finger input sensor.

According to the present invention, a guiding method of a fingerprint impressing position for guiding a finger placed on a fingerprint input sensor by an individual to be identified to a proper fingerprint impressing position in a fingerprint identification system, includes: a step of reading a fingerprint from the finger placed on the fingerprint input sensor; a step of determining a center of the fingerprint which is acquired by the fingerprint input sensor; a step of calculating a gap between a center of the fingerprint input sensor and the center of the fingerprint; and a step of notifying a move direction of the finger to the individual based upon the gap.

According to the present invention, a fingerprint identification system includes: a fingerprint input sensor on which an individual to be identified places a finger, which reads a fingerprint from the finger; a processor which determines a center of the fingerprint which is read by the fingerprint input sensor and calculates a gap between a center of the fingerprint input sensor and the center of the fingerprint; and a guiding unit which notifies a move direction to the individual based upon the gap and guides the finger to a proper position.

### BRIEF DESCRIPTION OF THE DRAWINGS

These and other objects, features and advantages of the invention will become more apparent from the following detailed description when taken in conjunction with the accompanying drawings, in which:

FIG. 1 is a schematic diagram for showing an arrangement of a fingerprint identification system according to a first embodiment mode of the present invention;

FIG. 2 is a flow chart for describing operations of the fingerprint identification system indicated in FIG. 1.

FIG. 3 is a flow chart for explaining a method of guiding a fingerprint impressing position in the fingerprint identification system shown in FIG. 1;

FIGS. 4(a) to 4(d) are a diagram for explaining a coordinate positional relationship between a fingerprint input sensor and an inputted fingerprint (fingerprint data);

FIG. 5 is a schematic diagram for representing an arrangement of a fingerprint identification system according to a second embodiment mode of the present invention; and

FIG. 6 is a schematic diagram for representing an arrangement of a fingerprint identification system according to a third embodiment mode of the present invention;

### DESCRIPTION OF THE PREFERRED EMBODIMENTS

Next, the present invention will be explained in detail below in reference to the accompanying drawings.

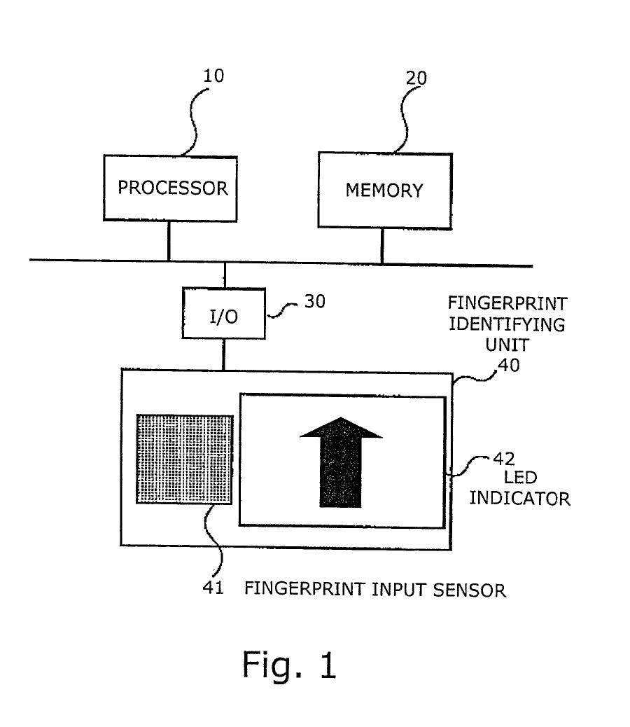

Referring to FIG. 1, a fingerprint identification system, according to a first embodiment of the present invention, includes a processor 10, a memory 20, an input/output interface (I/O) 30, and a fingerprint identifying unit 40. The memory 20 stores thereinto a program for causing the processor 10 to execute a method of guiding a fingerprint impressing position (will be discussed in detail later on) according to this embodiment.

The fingerprint identifying unit 40 includes a fingerprint input sensor 41 and an LED indicator 42. An individual to be identified puts his/her finger on the fingerprint input sensor 41. Here, the presently-available techniques such as a CCD and an electrical capacitance type sensor may be applied to the fingerprint input sensor 41. The LED indicator 42 guides a move direction of a finger to an individual to be identified by displaying characters of “↓”, “↑”, “→”, and “←”

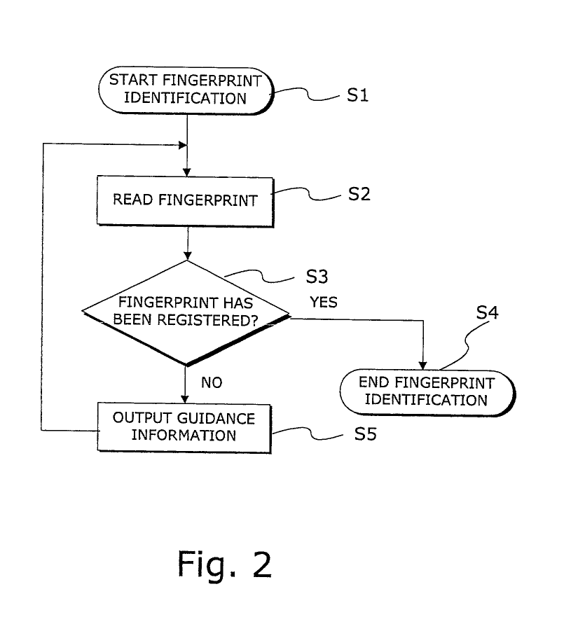

Next, referring to FIG. 2 to FIG. 4, operations of the fingerprint identification system according to this embodiment will be explained, more specifically, a description is made of a method of guiding a fingerprint impressing position in accordance with this embodiment.

Referring to FIG. 2, when an individual to be identified positions the own finger on the fingerprint input sensor 41 so as to commence the fingerprint identification (step S1), the fingerprint identification system electronically reads out a fingerprint from the finger positioned on the fingerprint input sensor 41 (step S2).

Next, the processor 10 judges whether or not the fingerprint acquired by the fingerprint input sensor 41 (namely, fingerprint data) is made coincident with a previously registered fingerprint of a registered individual (step S3). In the case that the processor 10 judges “coincident (Yes),” the processor 10 accomplishes the fingerprint identification processing operation, assuming that the fingerprint identification is a success succeed (step S4). On the other hand, in the case that the processor 10 judges “not coincident (No)” at the step S3, the processor 10 outputs guidance information with respect to the LED indicator 42 (step S5), and is brought into a waiting state until the individual to be identified moves his/her finger and the fingerprint acquiring operation is again carried out.

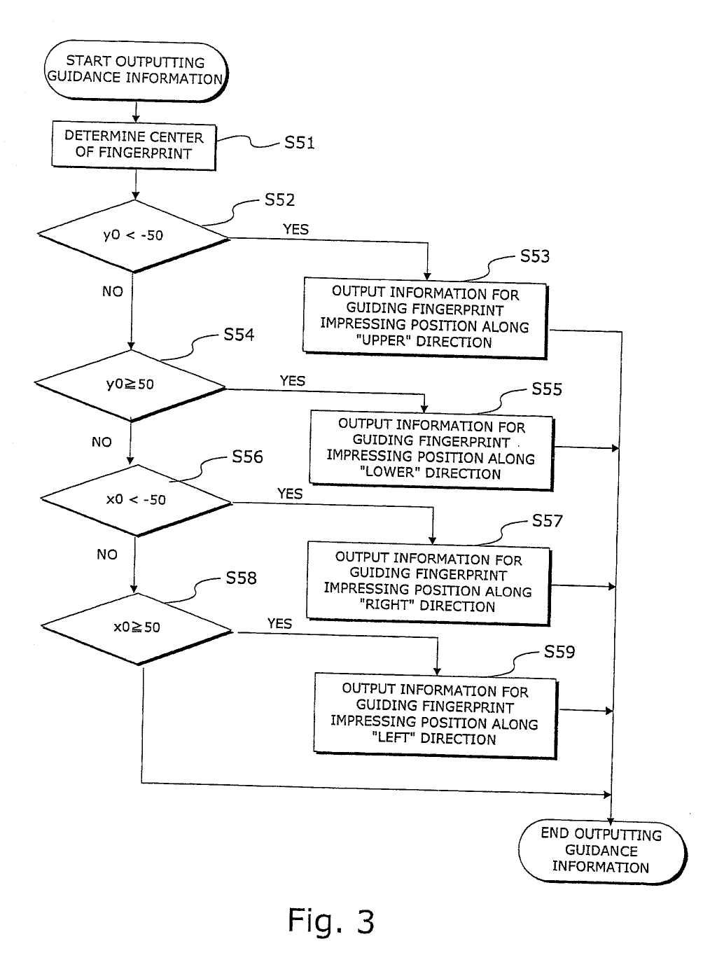

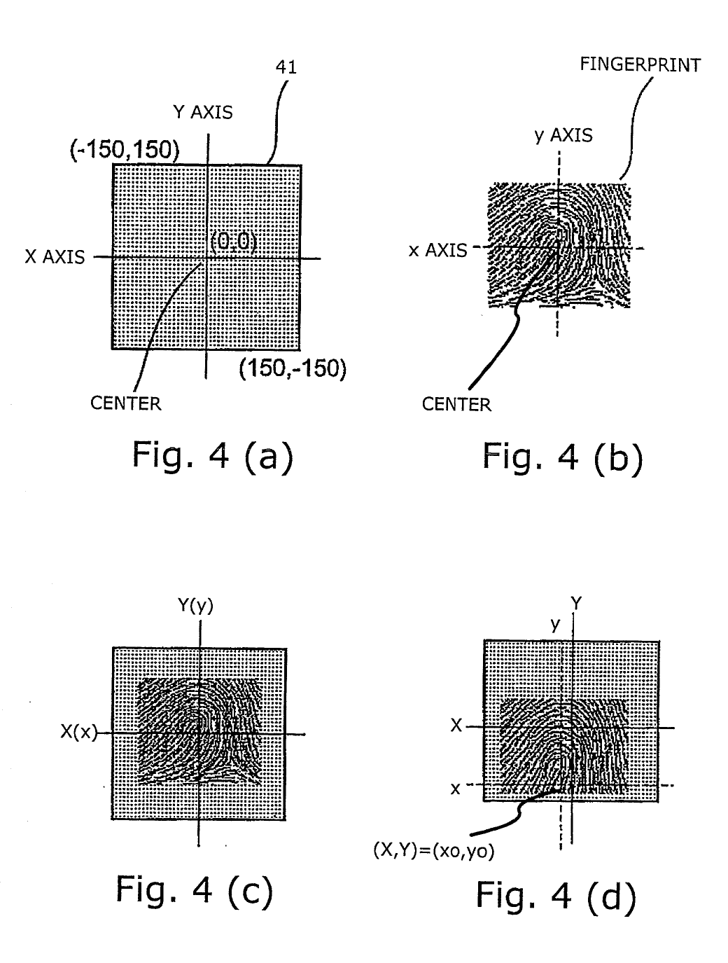

Here, the contents as to the step S5 will now be explained more in detail with reference to FIG. 3 and FIG. 4. First, an axis of the fingerprint input sensor 41 is previously determined as shown in FIG. 4(a). Under this condition, the processor 10 determines an axis of the fingerprint and a center of the fingerprint (see FIG. 4(b)) which is acquired at the above-described step S2 (step S51).

Then, the processor 10 judges whether a gap between a center of the fingerprint input sensor 41 ((X, Y)=(0, 0): will be referred to X₀, Y₀) and a center of the fingerprint ((X, Y)=(x₀, y₀): will be referred to x₀, y₀) is large than a predetermined amount. FIG. 4(c) show the center of the fingerprint just corresponds to the center of the fingerprint input sensor 41. FIG. 4(d) shows that the gap is large than the predetermined amount. Here, the predetermined amount corresponds to an allowable shift amount.

In this case, as shown in FIG. 4(a), in the fingerprint identification system according to this embodiment, the fingerprint input sensor 41 is defined as such a range of “−150≦Y<150, −150≦X<150,” and it is assumed that a range defined by “−50≦Y<50, −50≦X<50” is used as an effective range. In other words, in this embodiment, there is no erroneous fingerprint input operation as long as the center of the fingerprint is entered within this range of “−50≦Y<50, −50≦X 50.” As a consequence, the allowable shift amount is defined by “−50≦y₀<50, −50≦x₀<50” in this embodiment.

In particular, in accordance with this embodiment, the gap is separately judged with respect to each of the upper/lower/right/left directions on the fingerprint input sensors 41. Concretely speaking, the processor 10 first judges whether or not the center of the fingerprint meets a condition, “y₀<−50” (step S52). As a result of this judgement, in the case that the center of the fingerprint meets the condition “y₀<−50,” the processor 10 instructs the LED indicator 42 to display thereon such an indication “↑” in order to guide the fingerprint impressing position along the upper direction (step S53). In the case that the center of the fingerprint meets a condition, “y₀≧−50,” subsequently, the processor 10 judges whether or not the center of the fingerprint meets a condition, “y₀≧50” (step S54). As a result of the judgement performed at the step S54, in the case that the center of the fingerprint meets the condition, “y₀≧50,” the processor 10 instructs the LED indicator 42 to display thereon such an indication “↓” in order to guide the fingerprint impressing position along the lower direction (step S55). In the case that the center of the fingerprint meets a condition, “y₀<50,” subsequently, the processor 10 judges whether or not the center of the fingerprint meets a condition, “x₀<−50” (step S56). As a result of the judgement performed at the step S56, in the case that the center of the fingerprint meets the condition, “x₀<−50,” the processor 10 instructs the LED indicator 42 to display thereon such an indication “→” in order to guide the fingerprint impressing position along the right direction (step S57). In the case that the center of the fingerprint meets a condition, “x₀≧−50,” subsequently, the processor 10 judges whether or not the center of the fingerprint meets a condition, “x₀≧50” (step S58). As a result of the judgement performed at the step S58, in the case that the center of the fingerprint meets the condition, “x₀≧50,” the processor 10 instructs the LED indicator 42 to display thereon such an indication “←” in order to guide the fingerprint impressing position along the left direction (step S59).

Assuming now that as a result of the judgement made at the step S58, the center of the fingerprint meets a condition, “x₀<50,” since this case implies that the fingerprint impressing position need not be guided, no guidance is carried out, and the identification process operation is returned to the step S2 in FIG. 2. At this step S2, the fingerprint acquisition operation is again carried out. The case in which the judgement is made of “No” at the step S58 is given as follows: That is, for example, the individual to be identified does not put his/her finger on the fingerprint input sensor 41; the fingerprint data of the individual to be identified is made coincident with the previously-registered fingerprint data; and although the fingerprint data of the-individual to be identified is not made coincident with the previously-registered fingerprint data, the center of the fingerprint is present within the previously-indicated effective range.

Since such an arrangement is employed, in accordance with this embodiment, even when the erroneous fingerprint input operation is carried out in the fingerprint identification, the correction direction (namely, move direction of finger) of the fingerprint impressing position can be notified by the LED indicator 42 with respect to the individual to be identified while the subsequent fingerprint identification is carried out. As a result, since the individual to be identified can visibly recognize the move direction of the finger, the repetition of the erroneous fingerprint input operation can be reduced.

In the above-described embodiment, such a judgement that the fingerprint impressing position can be inputted to the proper input position with respect to the fingerprint input sensor may be made in the case where the center of the fingerprint is located within the effective range of “−50≦y₀<50, −50≦x₀<50.” This reason is given as follows: In the case where a total number of effective pixels of the fingerprint input sensor 41 is expressed as “−150≦Y<150, −150≦X<150,” ⅓ of these total effective pixel numbers along the respective directions are employed as approximated values. Assuming now that this approximated value is selected to be ¼ of these total effective pixel numbers, a narrower effective range may be set. Also, assuming now that this approximated value is selected to be ⅖ of these total effective pixel numbers, a wider effective range may be set.

Also, in the above-explained embodiment, the gap between a center of the fingerprint input sensor 41 and a center of the fingerprint are sequentially evaluated along the minus direction of the Y axis, the plus direction of the Y axis, the minus direction of the X axis, and the plus direction of the X axis. Alternatively, these evaluation orders may be replaced. Furthermore, alternatively, the guidance information of the fingerprint impressing position may be outputted to the indicator with respect to such a direction having a maximum amount of a gap.

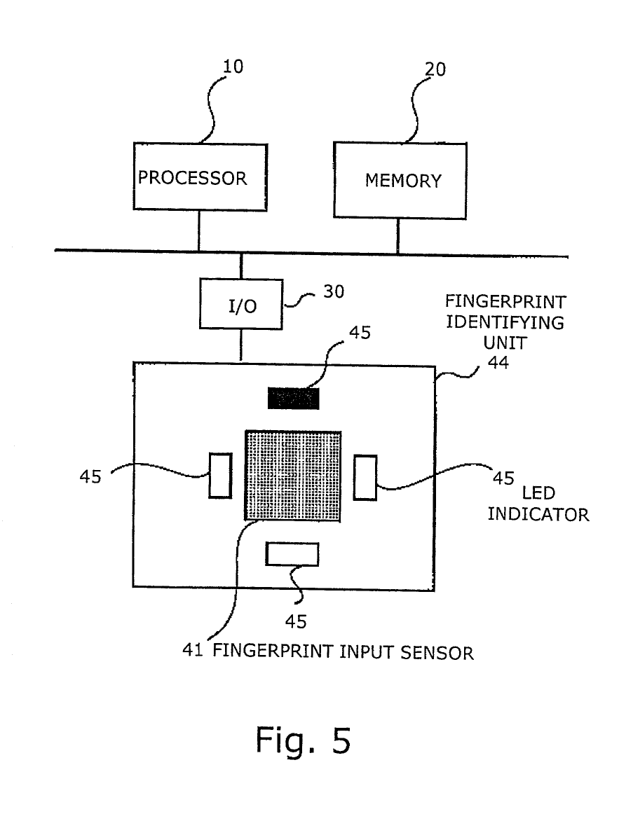

Next, a second embodiment of the present invention will be explained below. A fingerprint identification system according to the second embodiment of the present invention corresponds to a modification of the above-explained fingerprint identification system according to the first embodiment, and owns the same constructions as those of the fingerprint identification system according to the first embodiment mode, except for such a technical point that a fingerprint identifying unit 44 indicated in FIG. 5 is employed instead of the fingerprint identifying unit 40 shown in FIG. 1.

Referring to FIG. 5, the fingerprint identifying unit 44 includes a fingerprint input sensor 41, and 4 sets of LED indicators 45 which are provided in such a manner that these LED indicators are located to surround this fingerprint input sensor 41 from four positions. These four LED indicators 45 are employed in order to indicate a move direction of a finger to an individual to be identified in accordance with a method of guiding a fingerprint impressing position according to this embodiment. These LED indicators 45 are arranged in such a manner that such an LED indicator 45 corresponding to a finger move direction is turned ON.

Operations of such a fingerprint identification system are identical to the operations of the fingerprint identification system according to the first embodiment, which have been explained by employing FIG. 2 to FIG. 4, except for the below-mentioned points. In other words, in the fingerprint identification system according to this embodiment, at the respective steps S53, S55, S57 and S59 shown in FIG. 3, the processor 10 turns ON the “upper” LED indicator 45, the “lower”LED indicator 45, the “right” LED indicator 45, and the “left”LED indicator 45, corresponding to the “upper”, “lower”, “right”, and “left” directions, in order that the fingerprint impressing w position is guided to the “upper”, “lower”, “right”, and “left” directions, respectively.

Since such an arrangement is employed, in accordance with this embodiment, even when the erroneous fingerprint input operation is carried out in the fingerprint identification, the correction direction (namely, move direction of finger) of the fingerprint impressing position can be notified by the LED indicator 45 with respect to the individual to be identified while the subsequent fingerprint identification is carried out. As a result, since the individual to be identified can visibly recognize the move direction of the finger, the repetition of the erroneous fingerprint input operation can be reduced.

It should also be noted the various sorts of modifications described in the explanations related to the fingerprint identification system according to the first embodiment may be applied also to the fingerprint identification system according to this embodiment mode.

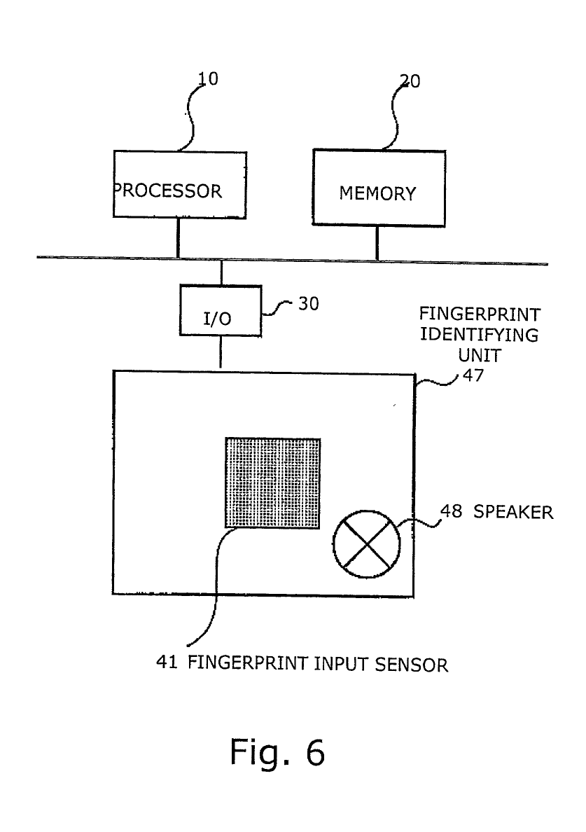

Next, a third embodiment of the present invention will be explained below. A fingerprint identification system according to the third embodiment of the present invention corresponds to a modification of the above-explained fingerprint identification system according to the first embodiment, and owns the same constructions as those of the fingerprint identification system according to the first embodiment, except for such a technical point that a fingerprint identifying unit 47 indicated in FIG. 6 is employed instead of the fingerprint identifying unit 40 shown in FIG. 1.

Referring to FIG. 6, the fingerprint identifying unit 47 includes a fingerprint input sensor 41, and a speaker 48 which is provided in the vicinity of this fingerprint input sensor 41. This speaker 48 is used so as to indicate a move direction of a finger by voice to an individual to be identified in accordance with a method of guiding a fingerprint impressing position according to this embodiment.

Operations of such a fingerprint identification system are identical to the operations of the fingerprint identification system according to the first embodiment, which have been explained by employing FIG. 2 to FIG. 4, except for the below-mentioned points. In other words, in the fingerprint identification system according to this embodiment, at the respective steps S53, S55, S57 and S59 shown in FIG. 2, the processor 10 transfers instructions to the individual to be identified via the speaker 48 by way of voice in order that the fingerprint impressing position is guided to the “upper”, “lower”, “right”, and “left” directions, respectively.

Since such an arrangement is employed, in accordance with this embodiment mode, even when the erroneous fingerprint input operation is carried out in the fingerprint identification, the correction direction (namely, move direction of finger) of the fingerprint impressing position can be notified by the speaker 48 with respect to the individual to be identified while the subsequent fingerprint identification is carried out. As a result, since the individual to be identified can audibly recognize the move direction of the finger, the repetition of the erroneous fingerprint input operation can be reduced.

It should also be noted the various sorts of modifications described in the explanations related to the fingerprint identification system according to the first embodiment may be applied also to the fingerprint identification system according to this embodiment.

In accordance with the present invention, when the erroneous fingerprint input operation to the fingerprint input sensor causes the failure in the fingerprint identification, since the concrete instruction capable of guiding the fingerprint impressing position is notified to the individual to be identified, possibility of succeeding in the subsequent fingerprint identification becomes extremely high.

Also, in accordance with the present invention, every time the individual to be identified mistakenly puts his/her finger on the fingerprint input sensor, this individual can recognize the deviation degree of the fingerprint impressing position. As a result, it can be expected that every time the individual to be identified repeats such an erroneous fingerprint input operation, this individual can learn it by himself/herself and can master the correct fingerprint input operation. As a consequence, it may be possible to reduce workloads which are required to notify a correct fingerprint inputting method of the fingerprint input sensor in detail to the individual to be identified, for example, just after the fingerprint identification system is introduced.

Moreover, in accordance with the present invention, while paying attention to such a fact that the information amount for guiding the fingerprint impressing position is limited, the LED indicators are employed as the transfer means of the guidance information without using such as an expensive display unit as an LCD. As a result, the production cost of the fingerprint identification system can be suppressed.

While this invention has been described in conjunction with the preferred embodiment described above, it will now be possible for those skilled in the art to put this invention into practice in various other manners.

What is claimed is:

1. A guiding method of a fingerprint impressing position for guiding a finger placed on a fingerprint input sensor by an individual to be identified to a proper fingerprint impressing position in a fingerprint identification system, comprising:
a step of reading a fingerprint from the finger placed on said fingerprint input sensor;
a step of determining a center of said fingerprint which is acquired by said fingerprint input sensor;
a step of calculating a gap between a center of said fingerprint input sensor and said center of said fingerprint; and
a step of notifying a move direction of the finger to said individual based upon said gap.

2. The guiding method of a fingerprint impressing position as claimed in claim 1, wherein the notification of the move direction of the finger with respect to said individual to be identified is carried out in such a manner that said finger move direction is displayed as an arrow with respect to a dot-displayable indicator provided in said fingerprint identification system.

3. The guiding method of a fingerprint impressing position as claimed in claim 1, wherein the notification of the move direction of the finger with respect to said individual to be identified is carried out in such a manner that among four indicators which are provided at four surrounding positions of said fingerprint input sensor in said fingerprint identification system, any one of the indicators, which corresponds to said finger move direction, is turned ON.

4. The guiding method of a fingerprint impressing position as claimed in claim 1, wherein the notification of the move direction of the finger with respect to said individual to be identified is carried out in such a manner that said finger move direction is transferred by voice to said individual to be identified via a speaker provided in said fingerprint identification system.

5. A fingerprint identification system comprising:
a fingerprint input sensor on which an individual to be identified places a finger, which reads a fingerprint from said finger;
a processor which determines a center of said fingerprint which is read by said fingerprint input sensor and calculates a gap between a center of said fingerprint input sensor and said center of said fingerprint; and
a guiding unit which notifies a move direction to said individual based upon said gap and guides the finger to a proper position.

6. The fingerprint identification system as claimed in claim 5, wherein said guiding unit comprises a dot-displayable indicator and displays said move direction as an arrow.

7. The fingerprint identification system as claimed in claim 5, wherein said guiding unit comprises four indicators provided at four surrounding positions of said fingerprint input sensor, one of said indicators corresponding to said move direction being turned ON.

8. The fingerprint identification system as claimed in claim 5, wherein said guiding unit comprises a speaker which guides said move direction by voice.
